(19) United States
(12) Patent Application Publication
(10) Pub. No.: US 2026/0009956 A1
(43) Pub. Date: Jan. 8, 2026

(54) MINIATURE VERTICAL OPTICAL MODULE

(71) Applicant: OptoMedia Technology Inc., Zhubei City (TW)

(72) Inventors: Hui-Tsuo CHOU, Zhubei City (TW); You-Jen CHEN, Zhubei City (TW); Ming-Hsiang HUANG, Zhubei City (TW)

(21) Appl. No.: 19/257,496

(22) Filed: Jul. 2, 2025

Related U.S. Application Data
(60) Provisional application No. 63/667,141, filed on Jul. 3, 2024.

(30) Foreign Application Priority Data
Jun. 20, 2025 (TW) 114123372

(51) Int. Cl. G02B 6/42

(52) U.S. Cl. CPC G02B 6/4278; G02B 6/4231; G02B 6/4281

(57) ABSTRACT

The present application discloses a miniature vertical optical module, comprising a housing, a control circuit board, an optical receiving unit, an optical transmitting unit, a signal connector, and a positioning component. One end of the signal connector is connected to the control circuit board, and the other end extends to form signal terminals. The soldering surface of the signal terminals is oriented either vertically or parallel to the bottom surface of the housing. One side of the positioning component is mounted on the housing, while the other side extends toward the circuit board. The extension direction of the positioning component is perpendicular to the soldering surface on the circuit board. The miniature vertical optical module of the present application is designed to be mounted at a vertical or inclined angle relative to the circuit board, and may be adjusted appropriately to align with the system housing.

### CROSS-REFERENCE TO RELATED APPLICATIONS

This application claims the benefit of U.S. Provisional Application No. 63/667,141, filed on Jul. 3rd, 2024, and Taiwan Patent Application No. 114123372, filed on Jun. 20, 2025, entitled “Miniature vertical optical module,” which is incorporated herein by reference in its entirety.

### TECHNICAL FIELD

The present application relates to an optical module, and more particularly, to a miniature vertical optical module.

### BACKGROUND OF THE INVENTION

In response to the need for high-speed computing in modern servers, higher transmission efficiency is required. Optical fiber transmission has become the mainstream approach. Fiber-optic communication is a method of transmitting information through light signals in optical fibers. Due to its advantages, such as large transmission capacity and excellent confidentiality, fiber-optic communication has become the primary form of wired communication. In the field of optical communication, optical connection devices are crucial components used for receiving and transmitting optical signals. These optical connection devices are primarily mounted on circuit boards and include an optical transmitter and an optical receiver. The optical transmitter converts electrical signals into optical signals for transmission through optical fibers, while the optical receiver converts received optical signals back into electrical signals and transmits them through the circuit board.

Existing optical modules are generally inserted along the direction of the circuit board, meaning that the optical module is arranged parallel to the circuit board. This design makes it difficult to insert fiber optic patch cords and may obstruct access to system panel

information. Furthermore, such parallel configurations occupy more surface area on the circuit board. For servers requiring high-efficiency heat dissipation, this setup hinders airflow through the module, causing heat buildup and poor thermal dissipation. Additionally, maintenance operations such as insertion and removal are more difficult.

### SUMMARY OF THE INVENTION

The primary purpose of the present application is to provide a miniature vertical optical module that can be suitably adjusted to fit a system enclosure and is arranged vertically or at an angle relative to a circuit board. This configuration allows easier insertion of optical fiber patch cords and prevents obstruction of information on the system panel.

Another purpose of the present application is to provide a miniature vertical optical module that, when arranged vertically or at an angle relative to the circuit board, offers better heat dissipation and facilitates easier subsequent insertion, removal, and maintenance.

To achieve the above purpose, the present application provides a miniature vertical optical module adapted to be disposed on a circuit board. The module includes: a housing, a control substrate, a light receiving unit, a light emitting unit, a signal connector, and a positioning member. The housing may be a two-piece structure, but is not limited thereto. The control substrate is disposed within the housing; the light receiving unit is electrically connected to the control substrate and receives optical signals; the light emitting unit is electrically connected to the control substrate and transmits optical signals. One end of the signal connector is connected to the side of the control substrate opposite the light emitting and receiving units, and the other end of the signal connector extends to form signal terminals. The soldering surface of the signal terminals is either perpendicular or parallel to the bottom surface of the housing. One side of the positioning member is disposed on the housing, and the other side of the positioning member extends toward the circuit board. The extending direction of the positioning member is perpendicular to the soldering surface on the circuit board.

In some embodiments, the extending direction of the positioning member is parallel to the directions of the light emitting and light receiving units.

In some embodiments, the extending direction of the housing is inclined relative to the soldering surface of the circuit board.

In some embodiments, the housing is provided with optical connection openings through which portions of the light receiving unit and the light emitting unit are exposed.

In some embodiments, the positioning member includes a disc portion that contacts a solder pad on the circuit board. The solder pad may include a through-hole to connect upper and lower solder pads, enhancing the structural strength of the miniature vertical optical module when fixed to the circuit board.

In some embodiments, the positioning member includes an extension portion which corresponds to a via-hole on the circuit board and can pass through the via-hole.

In some embodiments, the positioning member is made of metal or is a stamped sheet metal component. It may be a separate part or integrally formed with the housing. The positioning member includes a flat portion and a plurality of positioning pins. The flat portion is parallel to the soldering surface of the circuit board, and the flat portion is solderable thereto.

In some embodiments, the end of positioning pin is provided with a barb. When the optical fiber patch cord is in a locked state and subjected to pulling force, the barb enhances the tensile strength between the miniature vertical optical module and the circuit board. One or more barbs may be provided.

In some embodiments, a bushing is disposed outside the housing. The bushing may be made of metal or a material with electromagnetic shielding properties to enhance electromagnetic shielding performance and improve the mechanical strength of the module housing. The bushing improves electromagnetic interference (EMI) shielding.

In some embodiments, the bushing is made of metal or plastic material.

Through the use of the miniature vertical optical module of the present application, it can be suitably adjusted to match the system housing design and be installed vertically or at an angle. Optical fiber patch cords can be inserted quickly and easily without blocking system panel information. In addition, this configuration occupies a smaller surface area of the circuit board, which will improve the heat dissipation efficiency for servers with high heat dissipation requirements, and has the advantage of being easier to plug and unplug and maintain later.

To further understand the features and technical contents of the present application, various embodiments will be described in detail below with reference to the drawings. However, the embodiments are provided solely for illustrative purposes and do not limit the scope of the invention.

### BRIEF DESCRIPTION OF DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

Fig.1 shows an exploded structural schematic diagram of one embodiment of the present application;

Fig.2 shows an assembled structural schematic diagram of one embodiment of the present application;

Fig.3 shows a schematic diagram of one embodiment of the present application from another view;

Fig.4 shows a schematic diagram of the circuit board structure according to one embodiment of the present application;

Fig.5 shows an exploded structural schematic diagram of another embodiment of the present application;

Fig.6 shows a schematic diagram showing an inclined state of another embodiment of the present application;

Fig.7 shows a perspective schematic diagram of another embodiment of the present application; and

Fig.8 shows a front view schematic diagram of another embodiment of the present application.

### DETAILED DESCRIPTION OF THE INVENTION

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as "including but not limited to". "Substantial/substantially" means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an …” does not exclude other same elements existing in the process, the method, the article, or the device which includes the element.

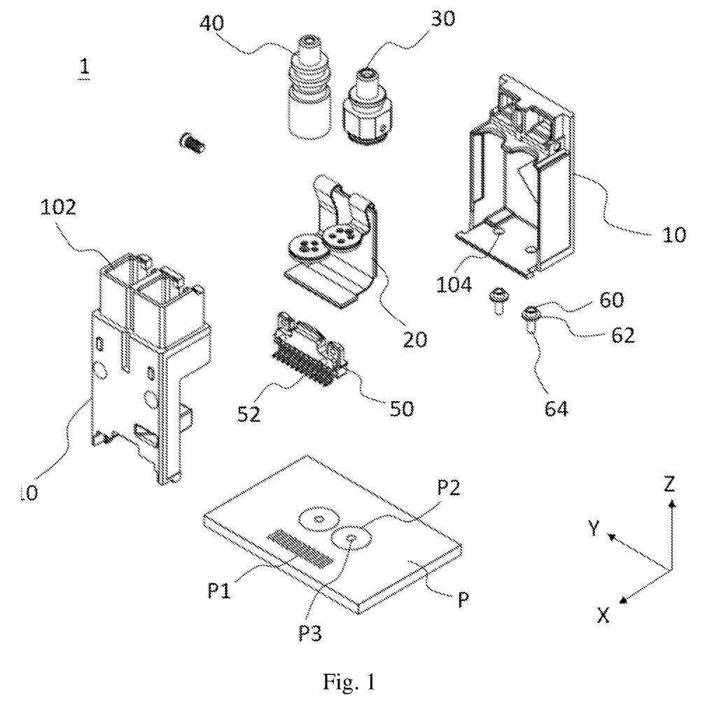

Please refer to Fig.1, which shows an exploded structural schematic diagram of one embodiment of the present application. As shown, the invention relates to a miniature vertical optical module 1, which is adapted to be disposed on a circuit board P. The miniature vertical optical module 1 includes a housing 10, a control substrate 20, an optical receiving unit 30, an optical transmitting unit 40, a signal connector 50, and a positioning member 60. The housing 10 may, for example, be a two-piece structure, but is not limited thereto. One side of the housing 10 is provided with optical connection holes 102 for exposing parts of the optical receiving unit 30 and optical transmitting unit 40 that are

connected to optical fiber patch cords. A positioning hole 104 is provided on the side of the housing 10 adjacent to the circuit board P. The positioning hole 104 can be used for the positioning member 60 to pass through, so that the housing 10 is positioned on the circuit board P. The control substrate 20 is disposed within the housing 10. The optical receiving unit 30 is electrically connected to the control substrate 20 and used to receive optical signals. The optical transmitting unit 40 is electrically connected to the control substrate 20 and is used to transmit optical signals. Both the optical receiving unit 30 and the optical transmitting unit 40 can be connected to optical fiber patch cords to receive or transmit optical signals. One end of the signal connector 50 is connected to the side of the control substrate 20 opposite to optical receiving unit 30 and the optical transmitting unit 40. The other end of the control substrate 20, adjacent to one end of the circuit board P, extends to form signal terminals 52. These signal terminals 52 are typically metal pins arranged in parallel. As shown in Fig.1, the signal terminals 52 are generally L-shaped, first extending downward (in the -Z direction), and then forward (in the +X direction). The bottom of the extended end of each terminal 52 forms a soldering surface (XY plane) that can be soldered to a solder joinst P1 on the circuit board P. In this embodiment, the soldering surface (XY plane) of the signal terminal 52 is parallel to the bottom surface direction (XY plane) of the housing 10.

Referring further to FIG. 1, a positioning hole 104 is formed under the housing 10. One side of the positioning member 60 is disposed on the housing 10 and passes through the positioning hole 104. The other side of the positioning member 60 extends toward the circuit board P. The extension direction of the positioning member 60 (-Z direction) is perpendicular to the soldering surface (XY plane) of the circuit board P. The positioning member 60 includes an extension part 64 that corresponds to and extends through a via-hole P3 on the circuit board P, thereby positioning the housing 10 on the circuit board P. Furthermore, the positioning member 60 has a disc portion 62, and the bottom surface of the disc portion 62 contacts and is soldered to a solder pad P2 on the circuit board P, thereby fixing the housing 10 to the circuit board P. In some embodiments, the extension direction (-Z direction) of the positioning member 60 is parallel to the direction (+Z direction) of the optical transmitting unit 40 and the optical receiving unit 30.

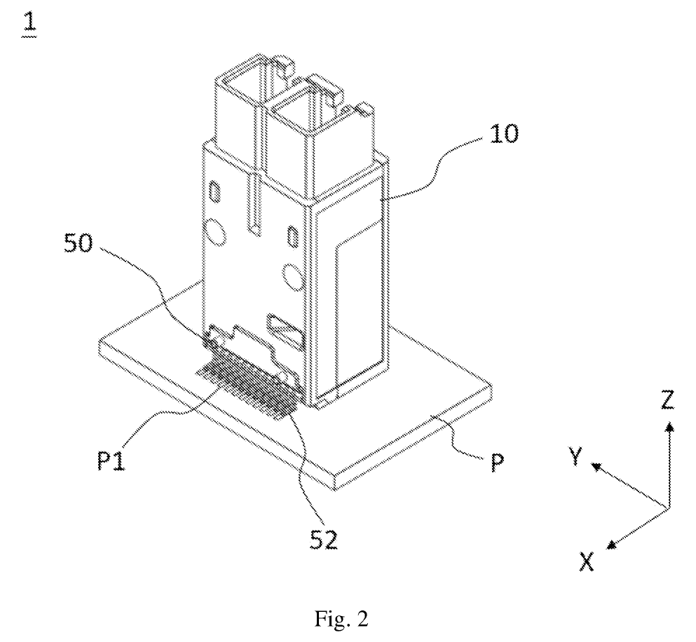

Fig.2 shows an assembled structural schematic diagram of one embodiment of the present application. Please also refer to Fig.1. As shown, the housing 10 of the miniature vertical optical module 1 is fixed on the circuit board P. This is achieved by soldering the soldering surface (XY plane) of the bottom of the extended signal terminals 52 to the solder joints P1 on the solder surface (XY plane) of the circuit board P, and by positioning the extension part 64 of the positioning member 60 through the via-hole P3 on the circuit board P and soldering the bottom surface of the disc portion 62 of the positioning member 60 to the solder pad P2 on the circuit board P and fixed the housing 10 on the circuit board P. Notably, the miniature vertical optical module 1 can be fixed to the circuit board P using SMD (Surface-Mount Device) soldering or through-hole soldering. In the case of through-hole soldering, the solder joints P1 on the circuit board P are replaced with through-holes penetrating the top and bottom surfaces of the circuit board P, and the signal terminals 52 are modified to extend directly downward (-Z direction, not shown). In this embodiment, the soldering surface (YZ plane) of the signal terminal 52 is perpendicular to the bottom surface direction (XY plane) of the housing 10.

The SMD soldering technique primarily secures the housing 10 of the miniature vertical optical module 1 to the circuit board P, thereby enhancing the bonding strength between the module and the circuit board P. The positioning member 60 of the miniature vertical optical module 1 includes a disc portion 62 and an extension part 64. The circuit board P and the extension part 64 with the disc portion 62 are connected by soldering, fixing the housing 10 to the circuit board P. This also grounds the housing 10 to the system’s ground, allowing fast dissipation of fault currents or high-voltage static to ground, and reducing electric shock risk.

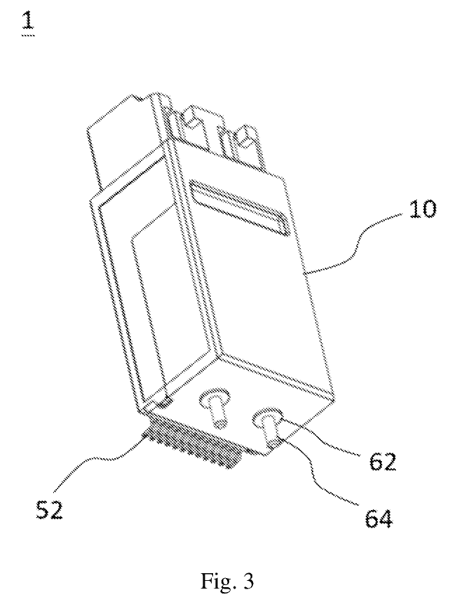

Fig.3 shows a schematic diagram of one embodiment of the present application from another view. Please also refer to Fig.1 and Fig.2. As shown, when the positioning member 60 is assembled to the housing 10, the disc portion 62 and the extension part 64 of the positioning member 60 are exposed outside the housing 10. The extension part 64 extends downward and passes through the via-hole P3 on the circuit board P for positioning, while the bottom surface of the disc portion 62 can be soldered to the solder pad P2 on the circuit board P, thereby fixing the housing 10 of the miniature vertical optical module 1 to the circuit board P.

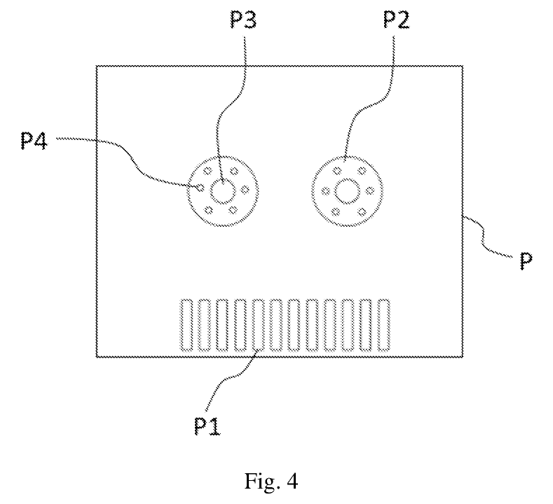

Fig.4 shows a schematic diagram of the circuit board structure according to one embodiment of the present application. As shown, the solder pads on the circuit board P may be formed with through-holes P4, which may be disposed, for example, around the peripheral area of the via-hole P3. These through-holes P4 connect the upper and lower solder pads of the circuit board P, thereby enhancing the structural strength when the miniature vertical optical module is fixed to the circuit board.

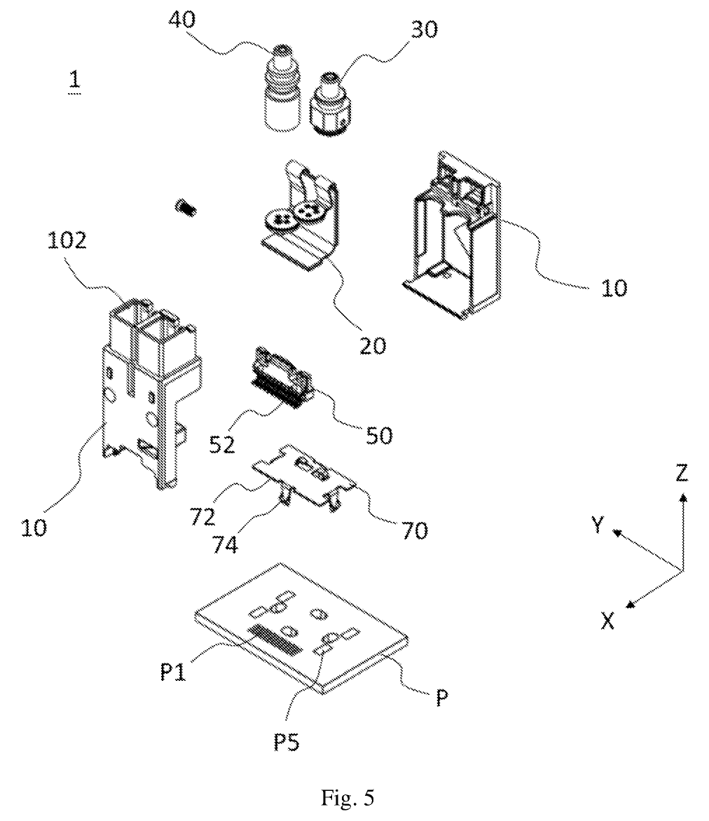

Fig.5 shows an exploded structural schematic diagram of another embodiment of the present application. As shown, in this embodiment, one side of the positioning member 70 is connected to the bottom surface of the housing 10, and the other side can be connected to the circuit board P. The positioning member 70 may be, for example, a metal component or a sheet metal stamping part. It may be an independent component or integrally formed with the housing, but is not limited thereto. The positioning member 70 includes a flat portion 72 and a plurality of positioning pins 74. The flat portion 72 (XY plane) is parallel to the soldering surface (XY plane) of the circuit board P and can be soldered to it. The positioning pins 74 extend downward and can be engaged with via through-holes P5 on the circuit board P. The ends of the positioning pins 74 may be provided with barbs. When the optical fiber patch cord is in a locked state and subjected to pulling force, the barbs can enhance the tensile strength between the miniature vertical optical module 1 and the circuit board P. The barb design may include one or more barbs and can have a multi-step structure to accommodate printed circuit boards P of different thicknesses.

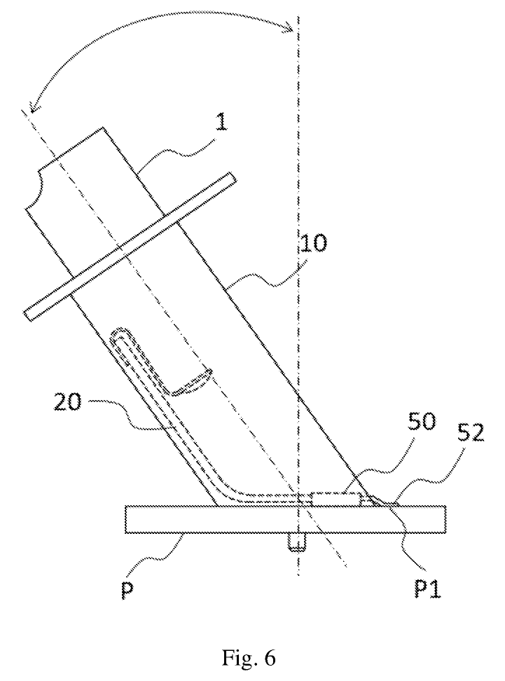

Fig.6 shows a schematic diagram showing an inclined state of another embodiment of the present application. As shown, in addition to vertical installation, the miniature vertical optical module 1 and the circuit board P may also be arranged at an inclined angle. For example, the housing 10 may be designed at an inclined angle relative to the circuit board P. The control substrate 20 in this invention can be a flexible printed circuit board, which can be attached to the housing 10 after modifying the tilt angle. The soldering surface of the signal terminal 52 of the signal connector 50 remains parallel or perpendicular to the bottom surface of the housing 10. Compared to conventional optical modules, in which the optical fiber patch cord is inserted in a direction horizontally parallel to the circuit board P, the optical fiber patch cord in this miniature vertical optical module 1 is inserted vertically

or at an inclined angle with respect to the circuit board P. This makes operation easier and avoids blocking information on the system panel.

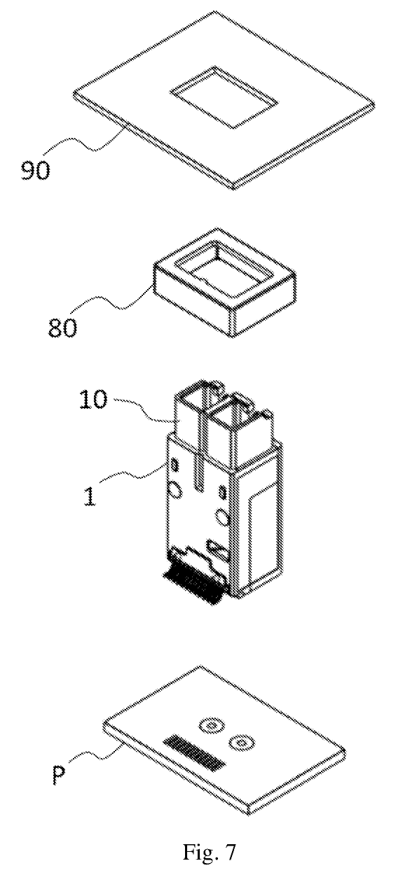

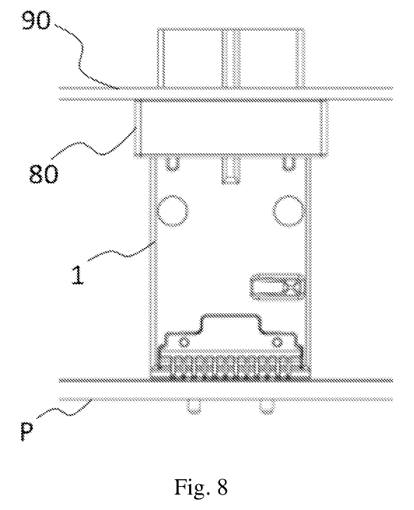

Fig.7 shows a perspective schematic diagram of another embodiment of the present application. Also referring to FIG. 8, Fig.8 shows a front view schematic diagram of another embodiment of the present application. A bushing 80 can be provided on the outside of the housing 10 of the miniature vertical optical module 1. The bushing 80 is fitted, for example, around the upper part of the housing 10 and between the system casing 90. The bushing 80 may be made of metal or any material with electromagnetic shielding properties, improving both electromagnetic shielding performance and enhancing structural fastening strength with the housing 10. The bushing 80 improves electromagnetic interference (EMI) shielding performance. The bushing 80 may be made of a metal material or an electromagnetic shielding material without limitation. When the miniature vertical optical module 1 is assembled with the system housing 90, the bushing 80 is disposed between the housing 10 of the miniature vertical optical module 1 and the system housing 90. The bushing 80 fills the gap between the miniature vertical optical module 1 and the system housing 90. By reducing the gap between the housing 10 and the system housing 90, the bushing 80 enhances EMI shielding effectiveness and increases the mechanical fastening strength between the optical module and the system housing 90. The bushing 80 can include elastic pieces (not shown) that make effective contact with the system casing 90 and fully cover the gap between the housing 10 of the miniature vertical optical module 1 and the system casing 90, preventing electromagnetic radiation leakage or external electromagnetic interference from affecting the system. The bushing 80 can also enhance tensile strength during fiber pulling, as the stress is resisted by the contact surface between the bushing 80 and the system casing 90, thereby preventing the separation of the module 1 from the circuit board P.

As described above, the bushing 80 may be a plastic structure with electromagnetic shielding properties. When the miniature vertical optical module 1 is assembled with the system casing 90, the plastic bushing 80 is positioned between the housing 10 and the system casing 90. When the optical fiber patch cord is pulled or subjected to force, the plastic bushing 80 strengthens the connection with the system casing 90 and utilizes the structure of the casing to resist the stress caused by the pulling of the fiber patch cord, thus preventing separation of the module 1 from the circuit board P.

In summary, the miniature vertical optical module of the present application can be vertically or obliquely connected to a circuit board and can be adjusted according to the system casing design. This allows easier operation during fiber patch cord insertion and avoids blocking information on the system panel. Moreover, this configuration occupies less surface area on the circuit board, which is beneficial for heat dissipation in servers with high thermal demands. It also simplifies subsequent maintenance and plug/unplug operations. Additionally, the bushing can be optionally added to enhance the overall structural strength, providing flexible and convenient use.

The above disclosure only illustrates preferred feasible embodiments of the present application and should not be construed as limiting the scope of the patent application. Any equivalent technical changes based on the description and drawings of the present application are included within the scope of the present patent application.

1. A miniature vertical optical module adapted to be disposed on a circuit board, the miniature vertical optical module comprising:
a housing;
a control substrate disposed within the housing;
a light receiving unit electrically connected to the control substrate and configured to
receive an optical signal;
a light emitting unit electrically connected to the control substrate and configured to emit an optical signal;
a signal connector, one end connected to a side of the control substrate opposite the light emitting unit and the light receiving unit, and the other end extending with signal terminals, wherein a soldering surface of the signal terminals is perpendicular or parallel to a bottom surface of the housing; and
a positioning member, one side disposed on the housing and the other side extends toward the circuit board, wherein extending direction of the positioning member is perpendicular to a soldering surface on the circuit board.

2. The miniature vertical optical module of claim 1, wherein the extending direction of the positioning member is parallel to the directions of the light emitting unit and the light receiving unit.

3. The miniature vertical optical module of claim 1, wherein the extending direction of the housing is inclined relative to the soldering surface of the circuit board.

4. The miniature vertical optical module of claim 1, wherein the positioning member includes a disc portion that contacts a solder pad on the circuit board.

5. The miniature vertical optical module of claim 1, wherein the positioning member includes an extension portion which corresponds to a via-hole on the circuit board and can pass through the through-hole.

6. The miniature vertical optical module of claim 1, wherein the positioning member is made of a metal part or stamped metal sheet, and may be a separate component or integrally formed with the housing.

7. The miniature vertical optical module of claim 1, wherein the positioning member includes a flat portion and a plurality of positioning pins.

8. The miniature vertical optical module of claim 7, wherein the flat portion is parallel to the soldering surface of the circuit board and the flat portion can be soldered on the soldering surface.

9. The miniature vertical optical module of claim 7, wherein the end of the positioning pin is provided with a barb.

10. The miniature vertical optical module of claim 1, wherein a bushing is disposed outside the housing, and the bushing is made of a metal material or a material having electromagnetic shielding properties to improve the electromagnetic shielding effect and enhance the fixing strength with the housing.

11. The miniature vertical optical module of claim 1, wherein the housing is inclined at an angle relative to the circuit board, and the soldering surface of the signal terminals is parallel or perpendicular to the bottom surface direction of the housing.

12. The miniature vertical optical module of claim 11, wherein the control substrate is a flexible circuit board that can conform to the inclined interior of the housing.

13. The miniature vertical optical module of claim 4, wherein the positioning member includes an extension portion which corresponds to a via-hole on the circuit board and can pass through the through-hole.

14. The miniature vertical optical module of claim 6, wherein the positioning member includes a flat portion and a plurality of positioning pins.
